(19) United States
(12) Patent Application Publication
(10) Pub. No.: US 2023/0204625 A1
(43) Pub. Date: Jun. 29, 2023

(54) SCANNING PROBE MICROSCOPE (SPM) TIP

(71) Applicant: NEXT-TIP, S.L., Madrid (ES)

(72) Inventors: Belén SANZ SANZ, Madrid (ES); Manuel ESPINOSA RODRÍGUEZ, Madrid (ES)

(21) Appl. No.: 17/998,815

(22) PCT Filed: May 17, 2021
(86) PCT No.: PCT/EP2021/062967

§ 371 Date: Nov. 15, 2022

(30) Foreign Application Priority Data
May 18, 2020 (EP) 20382415.6

(51) Int. Cl. G01Q 70/12; G01Q 70/18; G01Q 70/14; G01Q 60/38

(52) U.S. Cl. CPC G01Q 70/12; G01Q 70/18; G01Q 70/14; G01Q 60/38

(57) ABSTRACT

The present invention refers to a method for modifying a scanning probe microscope (SPM) tip, a modified SPM tip obtainable by the method, a modified SPM tip, to the use of the modified SPM tip, to a scanning probe comprising the modified SPM tip and to the use of the scanning probe.

### FIELD OF THE INVENTION

The present invention relates to the area of scanning probe microscope (SPM) tips. More specifically, the present invention relates to a method for modifying a scanning probe microscope (SPM) tip, a scanning probe microscope (SPM) tip, a scanning probe, and their uses.

### BACKGROUND

Scanning Probe Microscopy (SPM) and in particular, combined with spectroscopic techniques such as Tip Enhanced Raman Spectroscopy (TERS), Scattering Near-field Optical Microscopy (SNOM) and Fourier Transform Infrared (FTIR), need a continuous supply of new SPM tips with improved characteristics. However, modified SPM tips production is expensive, and usually, modified SPM tips have a reduced working life.

Some authors have described Atomic Force Microscopy (AFM) tips modified with nanoparticles. Patent Application No.EP2570815A1 describes tips coated by depositing nanoparticles generated by an ion cluster source. Despite an improvement of the topographical resolution of the nanoparticle coated AFM tips, said modified tip has several drawbacks such as lack of a significant improvement of the performance of the tip in certain AFM applications (such as Electrostatic Force Microscopy (EFM), Kelvin Probe Force Microscopy (KPFM), Conductive Atomic Force Microscopy (C-AFM), Piezo Force Microscopy (PFM), Tip Enhanced Raman spectroscopy (TERS), scattering-Scanning Near-Field Optical Microscopy (s-SNOM), Tip Enhanced Photolumiscence (TEPL), Tip Enhanced Fluorescence (TEF), Photothermal Infrared Spectroscopy (PTIR), nanoscale Fourier transform infrared (nano-FTIR) and Photo-Induced Force Microscopy (PiFM) atomic force microscopy techniques).

Alternatively, patent application WO2020/053358 describes a coated tip with an apex comprising a cluster of nanoparticles. In addition, the laterals of the tip are coated by a few scattered nanoparticles. Moreover, WO2020/053358 describes that there is no physical contact between the apex cluster and the scattered nanoparticles coating the laterals of the tip. The main drawback of the coating method described in WO2020/053358 is that it can lead to tip's damage and that increases the total cost of the manufacturing method. Also, the coated tip of WO2020/053358 wouldn't show a significant enhance of the signal in certain AFM applications.

Therefore, there is a clear need for new SPM tips with improved features and quality. In particular, improved performance in different atomic force microscopy techniques, strength, durability and reduced manufacturing cost.

### BRIEF DESCRIPTION OF THE INVENTION

The authors of the present invention have developed a modified scanning probe microscope (SPM) tip, a scanning probe comprising the modified SPM tip and their uses, and a method for modifying said SPM tip. In particular, it has been observed that the modified SPM tip of the present invention has a surprisingly improved performance over previous SPM tips, particularly in atomic force microscopy and more particularly, in tip enhanced Raman spectroscopy (TERS).

Therefore, a first aspect of the invention is directed to a method for modifying a scanning probe microscope (SPM) tip comprising the following steps:
(a) providing
   a nanoparticle beam;
      wherein the nanoparticle beam comprises a longitudinal axis X-X′ and an apex;
      wherein the longitudinal axis X-X′ passes through the apex of the nanoparticle beam and constitutes a symmetry axis;
      a SPM tip;
      wherein the SPM tip comprises an apex;
      wherein the SPM tip comprises a longitudinal axis Y-Y′; wherein the longitudinal axis Y-Y′ passes through the apex of the SPM tip and constitutes a symmetry axis;
   wherein the nanoparticle beam and/or the SPM tip perform a translational movement following a path on a xy plane around an axis W-W′; wherein the axis W-W′ is perpendicular to the xy plane;
   wherein axis X-X′, axis Y-Y′ and axis W-W′ meet at a point of the xy plane; wherein the distance of the apex of the SPM tip to said point of the xy plane is less than the distance of the apex of the nanoparticle beam to said point;
(b) confronting the SPM tip with the nanoparticle beam, wherein in its translational movement, the SPM tip passes through at least:
a. a position (a) wherein the axis X-X′ and the axis Y-Y′ form an angle of between −10° and −80°; and
b. a position (b) wherein the axis X-X′ and the axis Y-Y′ form an angle between −10° and +10°, preferably of 0°; and
c. optionally, a position (c) wherein the axis X-X′ and the axis Y-Y′ form an angle of between +10° and +80°; and
wherein the vertex of the angle is the point of the xy plane wherein axis X-X′, axis Y-Y′ and axis W-W′ meet;
to obtain a modified SPM tip.

In a second aspect, the present invention is directed to a modified SPM tip obtainable by the method of the present invention in any of its particulars embodiments.

In another aspect, the present invention is directed to a modified SPM tip comprising
an apex,
a base, and
at least a lateral surface,

wherein the at least a lateral surface comprises nanoparticle clusters with a length of at least 5 nm; wherein the nanoparticle clusters of the at least a lateral surface comprise a central rod and lateral protrusions;

wherein the nanoparticle clusters comprise metal nanoparticles with a mean diameter between 0.1 and 20 nm, and

wherein the apex comprises a nanoparticle cluster optionally of between 2 and 500 nanoparticles.

In an additional aspect, the present invention is directed to the use of the modified SPM tip of the invention in any of its particular embodiments for atomic force microscopy. In an additional aspect, the present invention is directed to a scanning probe comprising the modified SPM tip of the invention on a cantilever. In an additional aspect, the present invention is directed to the use of the scanning probe of the invention in any of its particular embodiments for atomic force microscopy.

### FIGURES

FIG. 1: Dynamic or tapping mode AFM image wherein the heights of three nanoparticles deposited on a flat surface are measured.

FIG. 2: Scanning electron microscopy micrographs of SPM coated tips.

FIG. 3: Representation of coated tips.

FIG. 4: Scanning electron microscopy micrograph of SPM coated tips.

FIG. 5: Scanning electron microscopy micrograph of SPM coated tips.

FIG. 6: Sketch of a modification method of a SPM coated tip.

FIG. 7: (a) Nano-FTIR amplitude spectrum recorded from a silicon surface and (b) Nano-FTIR absorption spectrum from a thin film of PMMA using a SPM coated tip (i) and a Pt/Ir commercial tip (ii).

FIG. 8: FIG. 8 Raman spectra obtained using a SPM coated tip on sample by a Tip Enhanced Raman spectroscopy (TERS) technique.

### DETAILED DESCRIPTION OF THE INVENTION

Unless defined otherwise, all technical and scientific terms used herein have the same meaning as commonly understood to one of ordinary skill in the art to which this disclosure belongs. As used herein, the singular forms “a” “an” and “the” include plural reference unless the context clearly dictates otherwise.

### Method

As defined above, a first aspect of the invention is directed to a method for modifying a scanning probe microscope (SPM) tip comprising the following steps:
(a) providing
   a nanoparticle beam;
      wherein the nanoparticle beam comprises a longitudinal axis X-X′ and an apex; wherein the longitudinal axis X-X′ passes through the apex of the nanoparticle beam and constitutes a symmetry axis;
   a SPM tip;
      wherein the SPM tip comprises an apex;
      wherein the SPM tip comprises a longitudinal axis Y-Y′; wherein the longitudinal axis Y-Y′ passes through the apex of the SPM tip and constitutes a symmetry axis;
   wherein either the nanoparticle beam and/or the SPM tip perform a translational movement following a path on a xy plane around an axis W-W′; wherein the axis W-W′ is perpendicular to the xy plane;
   wherein axis X-X′, axis Y-Y′ and axis W-W′ meet at a point of the xy plane; wherein the distance of the apex of the SPM tip to the point of said point of the xy plane is less than the distance of the apex of the nanoparticle beam to said point;
(b) confronting the SPM tip with the nanoparticle beam, wherein in its translational movement, the SPM tip passes through at least:
   a. a position (a) wherein the axis X-X′ and the axis Y-Y′ form an angle of between −10° and −80°; and
   b. a position (b) wherein the axis X-X′ and the axis Y-Y′ form an angle of between −10° and +10°, preferably of 0°; and
   c. optionally a position (c) wherein the axis X-X′ and the axis Y-Y′ form an angle of between +10° and +80°;
   wherein the vertex of the angle is the point of the xy plane wherein axis X-X′, axis Y-Y′ and axis W-W′ meet.

### Step (a)

The step (a) of the method of the invention is directed to providing
a nanoparticle beam;
wherein the nanoparticle beam comprises a longitudinal axis X-X′ and an apex; wherein the longitudinal axis X-X′ passes through the apex of the nanoparticle beam and constitutes a symmetry axis;
a SPM tip;
   wherein the SPM tip comprises an apex;
   wherein the SPM tip comprises a longitudinal axis Y-Y′; wherein the longitudinal axis Y-Y′ passes through the apex of the SPM tip and constitutes a symmetry axis;
   wherein either the nanoparticle beam and/or the SPM tip perform a translational movement following a path on a xy plane around an axis W-W′; wherein the axis W-W′ is perpendicular to the xy plane;
   wherein axis X-X′, axis Y-Y′ and axis W-W′ meet at a point of the xy plane; wherein the distance of the apex of the SPM tip to the point of said point of the xy plane is less than the distance of the apex of the nanoparticle beam to said point.

### SPM Tip of Step (a)

In the context of the present invention the expression “SPM tip” is understood as the tip “before” being modified by the method of the present invention in any of its embodiments.

In an embodiment, the SPM tip of step (a) further comprises a longitudinal axis Y-Y′; wherein the longitudinal axis Y-Y′ passes through the apex of the SPM tip and constitutes a symmetry axis. In an embodiment, the longitudinal axis Y-Y′ passes through the apex and through the center of the base of the SPM tip and constitutes a symmetry axis.

In an embodiment, the SPM tip of step (a) of the invention is a polyhedron; preferably a pyramid or a cone; more preferably a pyramid; preferably, a pyramid with three lateral sides. In an embodiment, the pyramid has an inclination.

In a particular embodiment, the SPM tip of step (a) is on a cantilever; preferably on the end of a cantilever.

In an embodiment, the SPM tip of step (a) is of any material known in the art; preferably is of a ceramic material; more preferably the ceramic material is selected from silicon, silicon nitride, silicon carbide (SiC), silicon carbonitride (SiCN), alumina (Al₂O₃), alumina-mullite, aluminum borosilicate and silica (SiO₂); preferably silicon (Si) or silicon nitride (Si₃N₄).

Also, in a further embodiment of the invention, the SPM tip of step (a) is not subject to any physical or chemical pre-treatment before the method of the present invention. Alternatively, in another particular embodiment, the SPM tip of step (a) is chemically functionalized.

In a particular embodiment, the SPM tip of step (a) comprises at least a metal layer coating. In an embodiment, the metal layer is a continuous metal nanoparticle layer. In an alternative embodiment, the metal layer is a continuous layer of a metal or of a metal alloy; preferably a continuous layer of Ag, Au, Al, W, Pt, Co, Fu, Cu, Pd and combinations thereof; more preferably is selected form Ag, Au and Pt; even more preferably is Ag or Au; even much more preferably is Ag.

In an embodiment, the at least a metal layer coating of the SPM tip of step (a) has a thickness of between 1 and 300 nm; preferably of between 5 and 200 nm; more preferably of between 40 and 100 nm.

### Nanoparticle Beam

In an embodiment, the nanoparticle beam is generated by any means suitable for generating a nanoparticle beam known in the art. In the context of the present invention, the expression “means suitable for generating a nanoparticle beam” refers to, for example an ion cluster source (ICS); preferably coupled with a metal target. In an embodiment, the ion cluster source comprise two chambers: in particular one wherein the nanoparticle beam is generated and a second chamber wherein the SPM tip is modified; particularly the two chambers are communicated by an opening and the nanoparticle beam is able to pass through said opening, preferably, wherein the apex of the nanoparticle beam of the second chamber is situated in said opening.

In an embodiment, the nanoparticle beam of step (a) is generated by a ion cluster source (ICS); in particular comprising a magnetron and working with an inert gas flow; preferably by applying a power to the magnetron of between 1 and 15 W; preferably of between 2 and 13 W and more preferably using a metal target. In an embodiment, the cluster ion source is a multi-ion cluster source (MICS).

In an embodiment, the method of the invention is performed inside a chamber; preferably an isolated chamber; more preferably a chamber at vacuum, high vacuum (HV) or at ultra high vacuum (UHV). In the method of the present invention, the SPM tip may be on a holder; preferably on a rotating holder; more preferably the SPM tip may be on a cantilever fixed on a holder.

The nanoparticle beam of step (a) may be generated by an ion cluster source (ICS) technique. In particular, by generating a plasma of ions of the desired material in a gas-controlled atmosphere; wherein said gas is preferably selected from argon, helium, nitrogen, oxygen or any combinations thereof, and more preferably argon or helium. In particular, a ion cluster source (ICS) based on gas condensation technique might be used to generate the nanoparticle beam, for example, a material is sputtered into a cooled, high pressure region by an ion cluster source (ICS), nanoparticles are formed insaid region (i.e. a chamber) and then, directed to the SPM tip as a nanoparticle beam. Usually, the SPM tip is in one chamber and the nanoparticle beam is generated in another chamber and the nanoparticle beam may enter in the chamber of the SPM tip by an opening.

The authors of the present invention have observed that when the nanoparticles of the nanoparticle beam of step (a) are generated by a ion cluster source (ICS), the nanoparticles keep their integrity and maintain their original shape after being deposited on the AFM tip. In addition, the authors of the present invention have observed those nanoparticles do not comprise impurities (have a high purity).

In an embodiment, the nanoparticle beam of the invention has a conical shape and comprises a longitudinal axis X-X′ and an apex; wherein the longitudinal axis X-X′ passes through the apex and through the center of the circular base of the nanoparticle beam cone thus, constituting a symmetry axis. Particularly, the radius of the base of the cone of the nanoparticle beam is increased with the distance between the base and the apex. Particularly, the nanoparticle beam is continuous and stable during time. In an embodiment, the nanoparticle beam of the invention is fixed (i.e. is not able to move). In a particular embodiment the nanoparticle beam is unidirectional. In a more particular embodiment, the nanoparticles inside the nanoparticle beam may move in any direction. In an even more particular embodiment, the nanoparticles of the nanoparticle beam may be as clusters of at least two particles in the nanoparticle beam.

In a more particular embodiment, the nanoparticles are metal nanoparticles; preferably the metal of the metal nanoparticles is selected from Ag, Au, Al, W, Pt, Co, Fu, Cu, Pd and combinations thereof; more preferably is selected form Ag, Au and Pt; even more preferably is Ag or Au; even much more preferably is Ag.

In a more particular embodiment, the nanoparticles are made of an alloy; preferably a homogeneous or heterogeneous alloy; preferably of a homogenous alloy.

In a more particular embodiment, the nanoparticles have a purity of at least 99.00 wt % (i.e. they comprise less than 1.00 wt % of impurities); preferably of at least 99.50 wt %; more preferably of at least 99.80 wt %; even more preferably of at least 99.90 wt %; even more preferably of at least 99.99 wt %.

In a more particular embodiment, the nanoparticles are pure, they do not have impurities.

In a more particular embodiment, the mean diameter of the nanoparticles is between 0.10 nm and 20 nm; preferably between 0.5 and 10 nm; more preferably between 1 and 5 nm; even more preferably between 2 and 4 nm. In an embodiment the nanoparticles are stable, homogeneous and monodisperse. Particularly, the mean diameter the nanoparticles was calculated from an average of the height values obtained by measuring more than 100 nanoparticles deposited on a flat silicon wafer surface wherein the height values were measured by atomic force microscopy (AFM) in tapping mode as known in the art.

In a particular embodiment, the nanoparticles have a core-shell or a Janus structure, i.e. comprise two materials in the same nanoparticle. This structure allows two or more different types of chemistry to occur on each same nanoparticle. The simplest case of a Janus nanoparticle is achieved by dividing the nanoparticle into two distinct parts, each of them either made of a different material, or bearing different functional groups. This gives these particles unique properties related to their asymmetric structure and/or functionalization.

In another particular embodiment, the nanoparticles have any shape; preferably the nanoparticles have rod, spherical of semispherical shape; more preferably the nanoparticles have a spherical or semispherical shape; preferably spherical shape.

In a preferred embodiment, the nanoparticles of the nanoparticle beam are metal nanoparticles wherein the metal of the metal nanoparticles is selected from Ag, Au and a combination thereof, and wherein the mean diameter of the nanoparticles is between 1 nm and 10 nm.

In a more preferred embodiment, the nanoparticles of the nanoparticle beam are Au spherical nanoparticles with a mean diameter of between 0.1 nm and 20 nm; preferably of between 0.5 and 10 nm; more preferably of between 1 and 5 nm.

In an embodiment the nanoparticle beam comprises nanoparticles; preferably comprises a nanoparticle density of between 50 and 2000 nanoparticles/pms in the plane xy of the base of the nanoparticle beam when the base of the particle beam is a distance of between 50 and 10000 mm from the apex.

In a particular embodiment the nanoparticle beam comprises nanoparticles; preferably comprises a nanoparticle density of between 200 and 1800 nanoparticles/pms in the plane xy of the base of the nanoparticle beam when the base of the particle beam is a distance of between 100 and 1000 mm from the apex.

In a more particular embodiment the nanoparticle beam comprises nanoparticles; preferably comprises a nanoparticle density of between 500 and 1600 nanoparticles/pms in the plane xy of the base of the nanoparticle beam when the base of the particle beam is a distance of between 150 and 350 mm from the apex of the SPM tip.

Particularly, the nanoparticle density of the nanoparticle beam was calculated by measuring the average number of nanoparticles deposited on a certain length (such a micron) of a flat surface (such a plane xy, for example 1 μm²) during a known number of seconds (for example 1 s) after the flat surface has been placed on the base of the nanoparticles cone during a certain amount of time. Preferably, the measurements are done by atomic force microscopy (AFM) in tapping mode as known in the art. In another particular embodiment, the density of nanoparticles of the nanoparticle beam is stable during time.

In another particular embodiment, the nanoparticle beam is continuous or intermittent in time (i.e. able to be switched on and off); preferably continuous in time. In another particular embodiment, the nanoparticle beam may be shut on and off.

### Translational Movement

Either the nanoparticle beam and/or the SPM tip perform a translational movement following a path on a xy plane around an axis W-W′; wherein the axis W-W′ is perpendicular to the xy plane. In an embodiment, the path is circular or semicircular; preferably circular.

In an embodiment, either the nanoparticle beam or the SPM tip perform a translational movement following a path on a xy plane around an axis W-W′; wherein the axis W-W′ is perpendicular to the xy plane. In an embodiment, the path is circular or semicircular; preferably circular.

In an embodiment, the nanoparticle beam performs a translational movement; preferably the SPM tip is fixed.

In an embodiment, the SPM tip performs a translational movement; preferably the nanoparticle beam is fixed.

In a particular embodiment, axis X-X′ and axis Y-Y′ are in the xy plane, thus they are perpendicular to axis W-W′.

In an embodiment, either the nanoparticle beam and/or the SPM tip perform a rotational movement; preferably around their longitudinal axis.

In another embodiment, the movement is continuous (i.e. without stopping). In a particular embodiment, the movement is performed at a continuous speed (no acceleration or deceleration).

In a particular embodiment, the translational movement is a circular or semicircular path;

preferably in one direction.

### Step (b)

Step (b) of the method of the present invention is directed to confronting the SPM tip with the nanoparticle beam, wherein in its translational movement, the SPM tip passes through at least:
a. a position (a) wherein the axis X-X′ and the axis Y-Y′ form an angle of between −10° and −80°; and
b. a position (b) wherein the axis X-X′ and the axis Y-Y′ form an angle of between −10° and +10°; preferably of 0°; and
c. optionally, a position (c) wherein the axis X-X′ and the axis Y-Y′ form an angle of between +10° and +80°;
wherein the vertex of the angle is the point of the xy plane wherein axis X-X′, axis Y-Y′ and axis W-W′ meet.

In the context of the present invention the expression “confronting the SPM tip with the nanoparticle beam” is directed to situating the SPM tip inside the nanoparticle beam, if the beam is conical, it means situating the SPM tip inside the cone. Thus, the nanoparticles can be deposited on the SPM tip; preferably on the tip lateral surfaces and/or on the tip apex.

In the context of the present invention, the expression “wherein in its translational movement” may refer to the translational movement of the method of the invention; particularly to the translational movement following a path on a xy plane around an axis W-W′ performed by the nanoparticle beam and/or the SPM tip. In the context of the present invention, the expression “passes through” may be interpreted as a static (such as “is in”) or dynamic expression (for example “moves”).

In a particular embodiment, in position (a), the axis X-X′ of the SPM tip and the axis Y-Y′ of the nanoparticle beam form an angle of between −10° and −80°; preferably of between −15° and −75°, more preferably of between −20° and −70°.

In a particular embodiment, in the position (b), the axis X-X′ and the axis Y-Y′ form an angle of between −10° and +10°; preferably of between −5° and +5°; more preferably between −3° and +3° ; even more preferably of 0° (i.e. the axis X-X′ and the axis Y-Y′ are aligned). In the context of the present invention, the term “aligned” means to be in the same straight line. In a particular embodiment, in position (b) the axis X-X′ and the axis Y-Y′ are in the same straight line.

In the context of the present invention, the expression directed to “an angle of 0°” regarding step (b), means that the axis X-X′ and the axis Y-Y′ are aligned, and therefore are situated in the same straight line.

In a particular embodiment, in the position (c), the axis X-X′ of the SPM tip and the axis Y-Y′ of the nanoparticle beam form an angle of between +10° and +80°; preferably of between +15° and +75°, more preferably of between +20° and +70°.

In a particular embodiment, the positions (a), (b) and/or (c) are different from each other.

In a more particular embodiment, the tip performs the translational movement from the position from (a) to (b), and optionally to (c); in a continuous or discontinuous way; preferably discontinuously (stopping in each position).

In another particular embodiment, the tip performs the translational movement from the position from (c) to (b), and optionally to (a), in a continuous or discontinuous way; preferably discontinuously (stopping in each position).

In another particular embodiment, the tip performs the translational movement from the position from (b) to (a), and optionally to (c), in a continuous or discontinuous way; preferably discontinuously (stopping in each position).

In another particular embodiment, the tip performs the translational movement reaching the different positions in any order; in a continuous or discontinuous way; preferably discontinuously (stopping in each position).

In a more particular embodiment, the SPM tip stops at each position of step (b); preferably for at least 0.1 second; preferably for at least 1 second; preferably for between 1 and 400 seconds; more preferably for between 2 and 300 seconds.

In a more particular embodiment, the SPM tip stops at each position of step (b); preferably for at least 0.01 second, 0.1 second, 1 second, 2 seconds, 5 seconds, 10 seconds, 50 seconds, 100 seconds; 200 seconds; 5 minutes or 10 minutes; preferably for at least 200 seconds.

In a particular embodiment, during the method of the present invention the apex of the particle beam is at a distance of at least 50 mm, 100 mm, 150 mm, 200 mm or 250 mm from the apex of the SPM tip; preferably at least 100 mm.

In a particular embodiment, during the method of the present invention the distance between the apex of the particle beam and the apex of the SPM tip is between 1 and 10000 mm; preferably between 50 and 500 mm; more preferably between 100 and 400 mm; even more preferably between 150 and 250 mm.

In a more particular embodiment, the SPM tip is under the nanoparticle beam in the three positions of step (b); wherein, nanoparticles from the nanoparticle beam may reach the tip surface.

In a particular embodiment, step (b) is repeated at least once; preferably at least twice; more preferably at least three times.

In a more particular embodiment positions (a) and (b) and/or (c) may be performed in any order; preferably from position (a) to position (b) and then, optionally to position (c).

In a more particular embodiment, positions (a) and (c) form an angle between them of between 10° and 160°, preferably of between 20° and 140°; wherein the vertex of the angle is the point of the xy plane wherein axis X-X′, axis Y-Y′ and axis W-W′ meet.

In an embodiment, the method of the invention is performed at atmospheric pressure, at vacuum, high vacuum (HV) or at ultra high vacuum (UHV); preferably under at vacuum, high vacuum (HV) or at ultra high vacuum (UHV); more preferably under high vacuum. In a particular embodiment, the method is performed under an inert gas such as N₂ or argon.

In an embodiment, the method of the invention consist of steps (a) and (b).

A method for modifying a scanning probe microscope (SPM) tip comprising the following steps:
(a) providing
   a nanoparticle beam;
      wherein the nanoparticle beam has a conical shape and comprises a longitudinal axis X-X′ and an apex; wherein the longitudinal axis X-X′ passes through the apex of the nanoparticle beam and constitutes a symmetry axis;
      wherein the nanoparticle beam is generated by an ion cluster source;
      wherein the nanoparticles of the nanoparticle beam are Ag, or Au metal nanoparticles with a mean diameter of between 1 and 5 nm;
   a SPM tip;
      wherein the SPM tip is a polyhedron comprising a base, an apex and lateral sides;
      wherein the SPM tip comprises a longitudinal axis Y-Y′ that passes through the apex and through the center of the base of the SPM tip and constitutes a symmetry axis;
   wherein the SPM tip performs a translational movement following a circular path on a xy plane around an axis W-W′; wherein the axis W-W′ is perpendicular to the xy plane;
   wherein axis X-X′, axis Y-Y′ and axis W-W′ meet at a point of the xy plane;
   wherein the distance of the apex of the SPM tip to said point is less than the distance of the apex of the nanoparticle beam to said point;
(b) confronting the SPM tip with the nanoparticle beam, wherein in its translational movement, the SPM tip passes through at least:
   i. a first position wherein the axis X-X′ and the axis Y-Y′ form an angle of between −10° and −80°; and
   ii. a second position wherein the axis X-X′ and the axis Y-Y′ form an angle of between −10° and +10°; and
   iii. a third position wherein the axis X-X′ and the axis Y-Y′ form an angle of between +5 and +80°;
      wherein the vertex of the angle is the point of the xy plane wherein axis X-X′, axis Y-Y′ and axis W-W′ meet; and
      wherein the SPM tip stops at each position for at least 1 second.

The authors of the present invention have observed that by modifying a SPM tip using the method of the invention in any of its embodiments, it is possible the fabrication of modified SPM tips with new functionalities for applications in different microscopy technologies such as for atomic force microscopy, preferably in combination with a spectroscopy technique such as Electrostatic Force Microscopy (EFM), Kelvin Probe Force Microscopy (KPFM), Conductive Atomic Force Microscopy (C-AFM), Piezo Force Microscopy (PFM), Tip Enhanced Raman spectroscopy (TERS), scattering-Scanning Near-Field Optical Microscopy (s-SNOM), Tip Enhanced Photolumiscence (TEPL), Tip Enhanced Fluorescence (TEF), Photothermal Infrared Spectroscopy (PTIR), nanoscale Fourier Transform Infrared (nano-FTIR) and Photo-Induced Force Microscopy (PiFM) atomic force microscopy techniques. The method of the invention is cost-effective and allows a tip modification in an easy and controlled way.

In a second aspect, the present invention is directed to a modified SPM tip obtainable by the method of the present invention in any of its particular embodiments.

All the following embodiments directed to the modified SPM tip may be applied to the aspect directed to a modified SPM tip obtainable by the method of the present invention, in any possible combination.

### Modified SPM Tip

In another aspect, the present invention is directed to a modified SPM tip comprising
an apex,
a base, and
at least a lateral surface,

wherein the at least a lateral surface comprises nanoparticle clusters with a length of at least 5 nm; wherein the nanoparticle clusters of the at least a lateral surface of the SPM tip comprise a central rod and lateral protrusions;

wherein the nanoparticle clusters comprise metal nanoparticles with a mean diameter between 0.1 and 20 nm; and

wherein the apex comprises a nanoparticle cluster optionally of between 2 and 500 nanoparticles.

The authors of the present invention have observed that the modified SPM of the invention in any of its embodiments has new functionalities and an improved performance in different microscopy technologies such as atomic force microscopy, tip enhanced Raman spectroscopy (TERS), scanning near-field optical microscopy (s-SNOM) and Fourier transform infrared (nano-FTIR).

### SPM Tip

In an embodiment, the SPM tip of the invention further comprises a longitudinal axis Y-Y′; wherein the longitudinal axis Y-Y′ passes through the apex of the SPM tip and constitutes a symmetry axis. In an embodiment, the longitudinal axis Y-Y′ passes through the apex and through the center of the base of the SPM tip and constitutes a symmetry axis.

In an embodiment, the SPM tip of the invention is a polyhedron; preferably a pyramid or a cone; more preferably a pyramid; preferably, a three lateral side pyramid.

In a particular embodiment, the SPM tip is on a cantilever; preferably on the end of a cantilever.

In an embodiment, the SPM tip is of any material known in the art; preferably is of a ceramic material; more preferably the ceramic material is selected from silicon, silicon nitride, silicon carbide (SiC), silicon carbonitride (SiCN), alumina (Al₂O₃), alumina-mullite, aluminum borosilicate and silica (SiO₂); preferably silicon (Si) or silicon nitride (Si₃N₄).

In a more particular embodiment, the modified SPM tip comprises at least a metal layer coating; wherein the nanoparticle clusters are on top of said at least a metal layer.

In an embodiment, the at least a metal layer is a metal layer of nanoparticles; preferably a continuous metal layer of nanoparticles, more preferably wherein the nanoparticles are in contact with each other (for example, they are packed forming a layer).

Alternatively, in another embodiment, the at least a metal layer is a continuous layer of a metal or of a metal alloy; preferably a continuous layer of Ag, Au, Al, W, Pt, Co, Fu, Cu, Pd and combinations thereof; more preferably is selected form Ag, Au and Pt; even more preferably is Ag or Au; even much more preferably is Ag.

In an embodiment, the at least a metal layer has a thickness of between 1 and 300 nm; preferably of between 5 and 200 nm; more preferably of between 40 and 100 nm.

In another particular embodiment, the modified SPM tip is chemically functionalized.

In a particular embodiment, the at least a lateral surface of the modified SPM tip further comprises at least a layer of metal nanoparticles, and nanoparticle clusters with lengths of at least 5 nm; wherein the nanoparticle clusters of the at least a lateral surface of the SPM tip comprise a central rod and lateral protrusions; wherein the nanoparticle clusters comprise metal nanoparticles with a mean diameter of between 0.1 and 20 nm; and wherein the nanoparticle clusters are on top of said at least a layer of metal nanoparticles. In a more particular embodiment, the at least a layer of nanoparticles is a continuous layer; preferably wherein the nanoparticles are in contact with each other. In an embodiment, the at least a lateral surface of the SPM tip comprise at least two layers of nanoparticles; preferably at least three layer of nanoparticles; more preferably at least four layers of nanoparticles. In a particular embodiment, each layer of nanoparticles comprise one layer of nanoparticles continuously packaged (i.e. in contact to each other) and covering all the surface available of the at least a lateral surface.

In an embodiment, all the lateral surfaces of the SPM Tip comprise nanoparticle clusters with lengths of at least 5 nm; preferably wherein the nanoparticle clusters of the lateral sides of the SPM tip are elongated rods with lateral protrusions. In an embodiment, the nanoparticle clusters are in contact with each other.

In an embodiment, the lateral surfaces of the SPM tip comprise between 1 and 100 layers of nanoparticles; preferably between 1 and 50 layers of nanoparticles; more preferably between 1 and 20 layers of nanoparticles.

The authors of the present invention have observed that when the modified SPM of the invention comprises a continuous metal layer, the signal in microscopy applications is improved.

### Clusters on the at Least One Lateral Surface

The at least one lateral surface of the modified SPM tip of the invention comprises nanoparticle clusters with a length of at least 5 nm; wherein the nanoparticle clusters of the at least a lateral surface of the SPM tip comprise a central rod and lateral protrusions; wherein the nanoparticle clusters comprise metal nanoparticles with a mean diameter between 0.1 and 20 nm. In a particular embodiment, the clusters are on the surface of the SPM tip or on the surface of the metal layer coating the SPM tip.

In an embodiment, the central rod of the nanoparticle clusters form an angle of between 30° and 90° with the at least one lateral surface; preferably between 60 and 90°. In an embodiment, the nanoparticle clusters are perpendicular to the at least one lateral surface.

In an embodiment, the SPM tip comprises a metal layer coating and the nanoparticle clusters are on top of the metal layer coating being in electrical contact with said metal layer; preferably wherein the nanoparticle clusters are not in contact with each other.

In a particular embodiment, the length of the nanoparticle clusters of the at least a lateral surface is at least 5 nm, 10, 20 or 30 nm; preferably a least 5 nm; more preferably at least 10 nm; even more preferably at least 20 nm; even much more preferably of at least 30 nm.

In a particular embodiment, the length of the nanoparticle clusters of the at least a lateral surface is between 5 and 60 nm; preferably between 5.5 and 300 nm; more preferably between 10 and 250 nm; even more preferably between 30 and 200 nm.

The dimensions of the nanoparticle clusters have been estimated by the average of the of the dimensions of about 100 clusters measured by electron microscopy techniques such as scanning electron microscopy techniques known in the art. In particular, the length of the nanoparticle clusters has been measured from the base of the cluster to the top of the cluster. In the context of the present invention, the expression “cluster length” relates to the longer dimension of a cluster. The cluster may have a coral-like shape comprising a central elongated rod and lateral protrusions or “branches”, then, the “cluster length” is directed to the dimension from the base to the top of the central rod of the cluster.

In a particular embodiment, the nanoparticle clusters of the at least a lateral surface comprise at least two nanoparticle, preferably at least three nanoparticles; more preferably at least four nanoparticles; even more preferably comprising at least 10 nanoparticles.

In another particular embodiment, the lateral surfaces of the modified SPM tip comprise nanoparticle clusters comprising between 2 and 80 nanoparticles; preferably between 3 and 50 nanoparticles; more preferably between 3 and 20 nanoparticles.

In a more particular embodiment, the mean diameter of the nanoparticles is between 0.10 nm and 20 nm; preferably between 1 and 10 nm, more preferably between 1 and 5 nm; even more preferably between 2 and 4 nm. In an embodiment, the nanoparticles are stable, homogeneous and monodisperse. Particularly, the mean diameter of the nanoparticles was calculated from an average of the values obtained by measuring more than 100 nanoparticles by scanning electron microscopy as known in the art.

In a more particular embodiment, the nanoparticles have a purity of at least 99.00 wt % (i.e. they comprise less than 1 wt % of impurities); preferably of at least 99.50 wt %; more preferably of at least 99.80 wt %; even more preferably of at least 99.90 wt %; even more preferably of at least 99.99 wt %. In a more particular embodiment, the nanoparticles are pure, (i.e. they do not comprise impurities)

In an embodiment, the nanoparticles are metal nanoparticles; preferably the metal of the metal nanoparticles is selected from Ag, Au, Al, W, Pt, Co, Fu, Cu, Pd and combinations thereof; more preferably is selected form Ag, Au and Pt; even more preferably is Ag or Au; even much more preferably is Au.

In another particular embodiment, the nanoparticle clusters of the lateral surfaces of the modified SPM tip are in contact with each other; preferably their sides are in contact; more preferably they are in contact with each other; preferably in electrical contact with each other.

In a particular embodiment, the nanoparticle clusters of the lateral sides of the SPM tip have an elongated shape; preferably a rod or wire shape; more preferably a rod shape.

In a more particular embodiment, the nanoparticle clusters of the lateral sides of the SPM tip have a branched or a coral-like shape. In a particular embodiment, the nanoparticle clusters are elongated and symmetrical about a central axis (that is, they are radially symmetrical) optionally with lateral protrusions; preferably they are elongated rods and symmetrical about a central longitudinal axis and have lateral protrusions; wherein the lateral protrusions are optionally branched-like.

In a particular embodiment, the at least a lateral surface of the modified SPM tip further comprises: at least a layer of metal nanoparticles; metal nanoparticle clusters with a length of at least 5 nm; wherein the clusters have a coral-like shape comprising a central elongated rod and lateral protrusions or “branches”; and wherein the nanoparticle clusters are on top of said at least a layer of metal nanoparticles.

In a more particular embodiment, the modified SPM tip comprises a continuous metal layer coating; optionally wherein the lateral sides comprise at least a continuous layer of nanoparticles on top of said continuous metal layer; and nanoparticle clusters with a length of at least 5 nm; wherein the nanoparticle clusters are on top of said at least a continuous metal layer or on top of the optional at least a continuous nanoparticle layer.

The authors of the present invention have found that, surprisingly, the presence nanoparticle clusters on the at least one lateral surface of the modified SPM tip having a length of at least 5 nm, leads to an improvement of the tip performance.

### Apex Cluster

In a particular embodiment, the apex of the modified SPM tip comprises at least one nanoparticle. The apex of the modified SPM tip comprises a nanoparticle cluster optionally comprising at least two nanoparticles, preferably at least three nanoparticles; more preferably at least four nanoparticles; even more preferably comprising at least 10, 20, 30, 40, 50, 60, 70, 80, 90 or 100 nanoparticles.

In another particular embodiment, the apex of the modified SPM tip comprises a nanoparticle cluster comprising between two and 500 nanoparticles; preferably between 3 and 450; more preferably between 4 and 300; even more preferably between 5 and 250 nanoparticles; more preferably between 6 and 150 nanoparticles, even more preferably between 7 and 100 nanoparticles.

In an embodiment, the nanoparticle clusters of the lateral surfaces of the modified SPM tip are not in contact with the nanoparticle cluster of the apex of the SPM tip.

The nanoparticle cluster of the apex of the SPM tip may have any shape; preferably has a rod, a wire, a spherical, a semispherical, an oval, a pinecone or an artichoke shape; preferably an oval, pinecone, flared, pointed egg or an artichoke shape; more preferably an oval shape.

In a particular embodiment, the SPM tip comprises a longitudinal axis Y-Y′; wherein the longitudinal axis Y-Y′ passes through the apex of the SPM tip and through the nanoparticle cluster and constitutes a symmetry axis; preferably wherein the diameter of the nanoparticle cluster of the apex of the SPM tip is perpendicular to the longitudinal axis Y-Y′; and more preferably wherein the value of the diameter of the nanoparticle cluster is smaller in the closest point to the apex and in the furthest point from the apex than in between those points along the longitudinal axis Y-Y′; even more preferably when moving along the longitudinal axis Y-Y′ from the closest point to the apex to the furthest point to the apex the diameter value increases, reaches a maximum value and then decreases; more preferably the diameter of the nanoparticle cluster decreases to end in a point.

In another particular embodiment, the apex of the modified SPM tip comprises a nanoparticle cluster with a maximum diameter value of between 2 and 500 nm; preferably of between 2 and 100 nm; wherein the maximum diameter value refers to the value of the diameter in the widest part of the cluster.

In another particular embodiment, the apex of the modified SPM tip comprises a nanoparticle cluster with a mean diameter of between 2 and 500 nm; preferably of between 2 and 100 nm; more preferably of between 3 and 90 nm; even more preferably of between 5 and 80 nm.

In another particular embodiment, the apex of the modified SPM tip comprises a pointed nanoparticle cluster; preferably having one nanoparticle at the end of the cluster.

In a more particular embodiment, the modified SPM tip is a pyramid comprising an apex, a base and lateral sides; wherein the apex comprises a nanoparticle cluster; wherein the lateral sides comprise at least a continuous layer of nanoparticles and nanoparticle clusters with a length of at least 5 nm; wherein the nanoparticle clusters are on top of said at least a continuous nanoparticle layer; and optionally, wherein the nanoparticle clusters of the lateral sides are in contact with each other.

In a more particular embodiment, the modified SPM tip is a pyramid comprising an apex, a base and lateral sides; wherein the SPM tip comprises a continuous metal layer coating; wherein the apex comprises a nanoparticle cluster; wherein the lateral sides comprise, optionally at least a continuous layer of nanoparticles on top of the continuous metal layer, and nanoparticle clusters with a length of at least 5 nm; wherein the nanoparticle clusters are on top of said at least a continuous metal layer or of the optional at least a continuous nanoparticle layer; and optionally, wherein the nanoparticle clusters of the lateral sides are in contact with each other.

In a more particular embodiment, the modified SPM tip is a cone comprising an apex, a base and lateral sides; wherein the apex comprises a nanoparticle cluster of between 5 and 100 nanoparticles; wherein the lateral sides comprise at least a layer of nanoparticles and nanoparticle clusters comprising between 2 and 50 nanoparticles; wherein the nanoparticle clusters are on top of said at least a layer or nanoparticles and optionally, wherein the nanoparticle clusters of the lateral sides are in contact with each other.

In a particular embodiment the modified SPM tip of the invention is a polyhedron comprising a base, an apex and lateral sides; wherein the apex comprises a nanoparticle cluster; and wherein the lateral sides comprise
at least a continuous layer of nanoparticles; and
nanoparticle clusters with a length of at least 5 nm; wherein the nanoparticle clusters are on top of said at least a layer or nanoparticles; and
wherein the nanoparticle clusters of the lateral sides of the SPM tip have a coral-like shape;

wherein the nanoparticles are metal nanoparticles; wherein the metal of the metal nanoparticles is selected from Ag, Pt or Au; and wherein the mean diameter of the nanoparticles is between 1 and 5 nm.

In a particular embodiment the modified SPM tip of the invention is a polyhedron comprising a base, an apex and lateral sides; wherein the apex comprises a nanoparticle cluster of between 2 and 100 nanoparticles; andwherein the lateral sides comprise
at least a continuous layer of nanoparticles; and
nanoparticle clusters of between 2 and 50 nanoparticles; wherein the nanoparticle clusters are on top of said at least a layer or nanoparticles; and
wherein the nanoparticle clusters of the lateral sides of the SPM tip have a coral-like shape;

wherein the nanoparticles are metal nanoparticles; wherein the metal of the metal nanoparticles is selected from Ag, Pt or Au; and wherein the mean diameter of the nanoparticles is between 1 and 5 nm.

In a particular embodiment the modified SPM tip of the invention is a pyramid comprising a base, an apex and lateral sides; wherein the apex comprises a nanoparticle cluster;

preferably of between 2 and 500 nanoparticles; and wherein the lateral sides comprise
at least a layer of nanoparticles; and
nanoparticle clusters comprising between 2 and 20 nanoparticles;

wherein the nanoparticle clusters are on top of said at least a layer or nanoparticles; and wherein the nanoparticle clusters of the lateral sides of the SPM tip have a coral-like shape;

and wherein the nanoparticles are metal nanoparticles; wherein the metal of the metal nanoparticles is selected from Ag, or Au; and wherein the mean diameter of the nanoparticles is between 1 and 5 nm.

The authors of the present invention have observed that the nanoparticle cluster of the apex of the modified SPM tip, improves the tip sharpness and resolution. Furthermore, the nanoparticle clusters of the at least one lateral surface, enhance the tip's local surface plasmon resonance, lighting rod and/or antenna effects, therefore, improving the tip's performance when it is used on tip enhanced Raman spectroscopy (TERS), scanning near-field optical microscopy (s-SNOM) and Fourier transform infrared spectroscopy (nano-FTIR) among other atomic force microscopy techniques.

### Uses of the Modified SPM Tip

In an additional aspect, the present invention is directed to use of the modified SPM tip of the invention in any of its particular embodiments, in atomic force microscopy, preferably in Electrostatic Force Microscopy (EFM), Kelvin Probe Force Microscopy (KPFM), Conductive Atomic Force Microscopy (C-AFM), Piezo Force Microscopy (PFM), Tip Enhanced Raman spectroscopy (TERS), scattering-Scanning Near-Field Optical Microscopy (s-SNOM), Tip Enhanced Photolumiscence (TEPL), Tip Enhanced Fluorescence (TEF), Photothermal Infrared Spectroscopy (PTIR), nanoscale Fourier transform infrared (nano-FTIR) and Photo-Induced Force Microscopy (PiFM) atomic force microscopy techniques.

### Scanning Probe

In an additional aspect, the present invention is directed to a scanning probe comprising the modified SPM tip on a cantilever; preferably mounted or fixed on a cantilever; more preferably on the end of a cantilever.

In an additional aspect, the present invention is directed to use of the scanning probe of the invention in any of its particular embodiments, in atomic force microscopy, preferably in Electrostatic Force Microscopy (EFM), Kelvin Probe Force Microscopy (KPFM), Conductive Atomic Force Microscopy (C-AFM), Piezo Force Microscopy (PFM), Tip Enhanced Raman spectroscopy (TERS), scattering-Scanning Near-Field Optical Microscopy (s-SNOM), Tip Enhanced Photolumiscence (TEPL), Tip Enhanced Fluorescence (TEF), Photothermal Infrared Spectroscopy (PTIR), nanoscale Fourier transform infrared (nano-FTIR) and Photo-Induced Force Microscopy (PiFM) atomic force microscopy techniques.

In an alternative aspect, the present invention is directed to an atomic force microscopy method comprising the SPM tip or the scanning probe of the invention in any of their particular embodiments; in a particular embodiment, the method may be directed to Electrostatic Force Microscopy (EFM), Kelvin Probe Force Microscopy (KPFM), Conductive Atomic Force Microscopy (C-AFM), Piezo Force Microscopy (PFM), Tip Enhanced Raman spectroscopy (TERS), scattering-Scanning Near-Field Optical Microscopy (s-SNOM), Tip Enhanced Photolumiscence (TEPL), Tip Enhanced Fluorescence (TEF), Photothermal Infrared Spectroscopy (PTIR), nanoscale Fourier transform infrared (nano-FTIR) or Photo-Induced Force Microscopy (PiFM) atomic force microscopy techniques.

As used herein, the terms “about” or “around” means a slight variation of the value specified, preferably within 10 percent of the value specified. Nevertheless, the term “about” or the term “around” can mean a higher tolerance of variation depending on for instance the experimental technique used. Said variations of a specified value are understood by the skilled person and are within the context of the present invention. Further, to provide a more concise description, some of the quantitative expressions given herein are not qualified with the term “about”. It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximation due to the experimental and/or measurement conditions for such given value.

All the features described in this specification (including the claims, description and drawings) and/or all the steps of the described method can be combined in any possible combination, with the exception of combinations of such mutually exclusive features and/or steps. In particular, the embodiments of the modified SPM tip may be combined in any possible way. The invention will be further illustrated by means of examples which should not be interpreted as limiting the scope of the claims.

### EXAMPLES

The invention is illustrated by means of the following examples which in no case limit the scope of the invention.

### EXAMPLE 1: Nanostructured coated tips

Commercial scanning probe microscope tips (atomic force microscopy (AFM) tips) were modified by depositing on them nanoparticles generated by an ion cluster source. A specifically designed ion cluster source (ICS) working at ultra-high vacuum conditions was used to generate a nanoparticle beam and deposit the nanoparticles on the tips. The ICS equipment is self-designed and has been assembled by parts from different trandemarks (Anstrom Angstron Sciences, Leybold, Kurt J.Lesker and Oxford Applied Research). ICS works under ultrahigh vacuum thus ensuring high chemical purity of the nanoparticle deposits on the tips. A nanoparticle beam of spherical 2-4 nm gold nanoparticles were produced by ICS using the following conditions: power applied to the magnetron, 7 W; clustering length 65 mm; argon flow: 90-110 sccm; distance between the diaphragm or aperture of the ion cluster and the tips: 180 mm and total deposition time: 5-10 min. A target of gold (99.99% purity) was used as target for ICS.

Gold nanoparticles were generated under the conditions described above and deposited on a flat surface during 1 second being the distance between the flat surface and the diaphragm or aperture of the equipment around 180 mm. Then, the nanoparticles were characterized by atomic force microscopy (AFM). FIG. 1 shows a tapping mode AFM image wherein the heights of three nanoparticles deposited on a flat surface are measured. The mean diameter the nanoparticles was calculated from an average of the height values obtained by measuring more than 100 nanoparticles deposited on a silicon wafer substrate by AFM. As can be seen from FIG. 1, 2-4 nm spherical gold nanoparticles were produced by ICS. Thus, the average height of the nanoparticles is comparative with the mean diameter of the nanoparticles. In a similar way, the average density of nanoparticles deposited on a surface was calculated (i.e. the number of nanoparticles deposited on a specific surface during a certain time).

The scanning probe microscope tips were fixed on a rotating platform holder. Then, the tips were coated with the gold nanoparticles generated by ICS. During the coating, each tip performs a translational movement following a circular path on a xy plane around an axis W-W′; wherein the axis W-W′ is perpendicular to the xy plane. The rotating platform holder was able to hold one or more tips and was able to perform a rotational movement around the rotation axis W-W′ and stop at different positions.

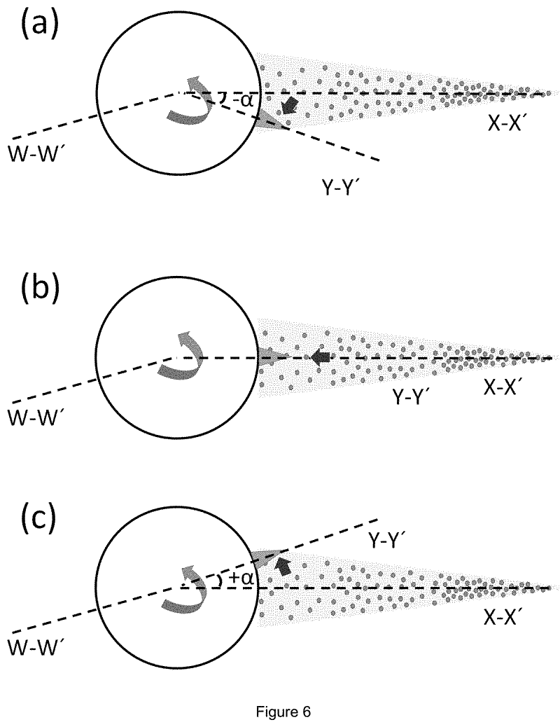

During the coating, a tip started at a first position (a), the holder rotates between −5° and −80° around said rotation axis W-W′ and the tip reached a second position (b). Then, after at least 0.1 seconds, the holder rotates between +5° and +80° around said rotation axis W-W′ and the tip reached a third position (c) (see FIG. 6). The holder may rotate back to the initial position (a) and or going back from position (c) to position (b) and then to position (a).The first position (a) and the third position (c) form an angle of between 10 and 160°, wherein the axis W-W′ is the vertex of the angle. The same movement may be repeated a certain number of times during the coating of a tip. The total coating deposition time was between 5 and 10 min. The tip moves at a continuous speed.

During the coating, the angle of incidence beam of nanoparticles and the tip was defined as the angle between their longitudinal symmetry axes (FIG. 6).The nanoparticle beam generated by an ion cluster source, had a conical shape and comprises a longitudinal axis X-X′, an apex and a base; wherein the longitudinal axis X-X′ passes through the apex of the nanoparticle beam and through the center of its base and constitutes a symmetry axis. In addition, the SPM tip had a pyramidal shape comprising an apex, a base and a longitudinal axis Y-Y′; wherein the longitudinal axis Y-Y′ passes through the apex of the SPM tip and through the center of the base of the tip and constitutes a symmetry axis.

Axis X-X′, axis Y-Y′ and axis W-W′ meet at a point of the xy plane (see FIG. 6). For example, at the first position (a) the axis X-X′ and the axis Y-Y′ formed an angle of between −5 and −80°. Then at the second position (b), the axis X-X′ and the axis Y-Y′ formed an angle of between −5 and +5, or even a 0° angle and at the third position (c) the axis X-X′ and the axis Y-Y′ formed an angle of between +5 and +80°. The vertex of the angle defined was the point of the xy plane wherein axis X-X′, axis Y-Y′ and an axis W-W′ meet. Since the translational movement of the tip is in one direction, positions (a) and (c) are different ones. Thus, the angle in position (a) may be defined as negative while the angle at position (c) may be defined as positive (see FIG. 6).

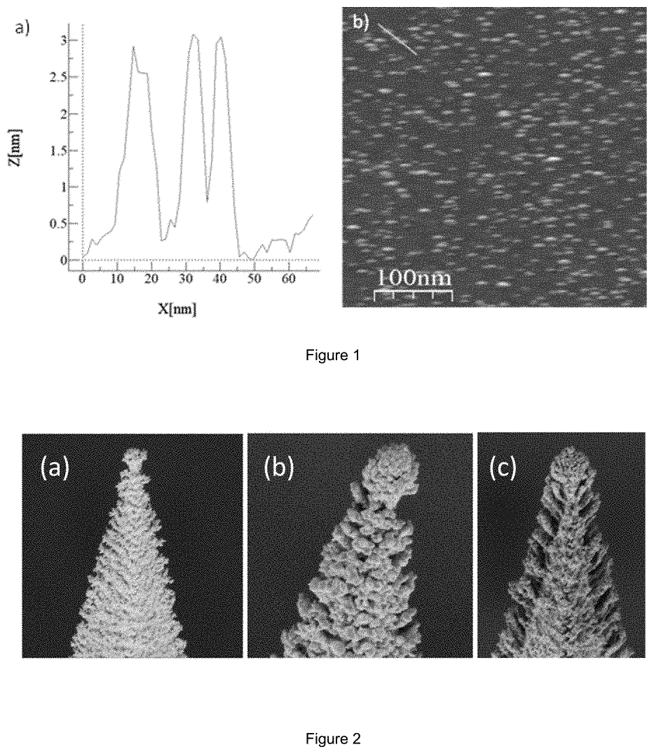

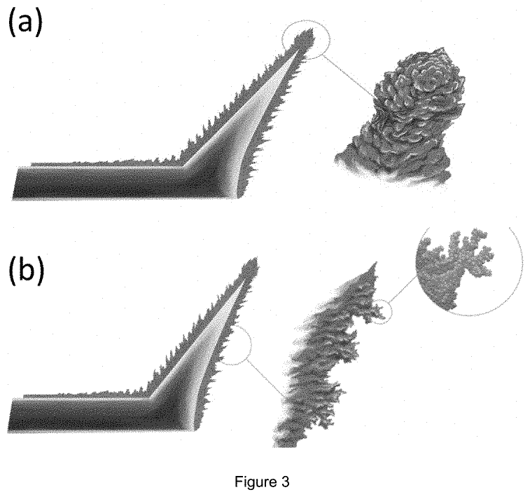

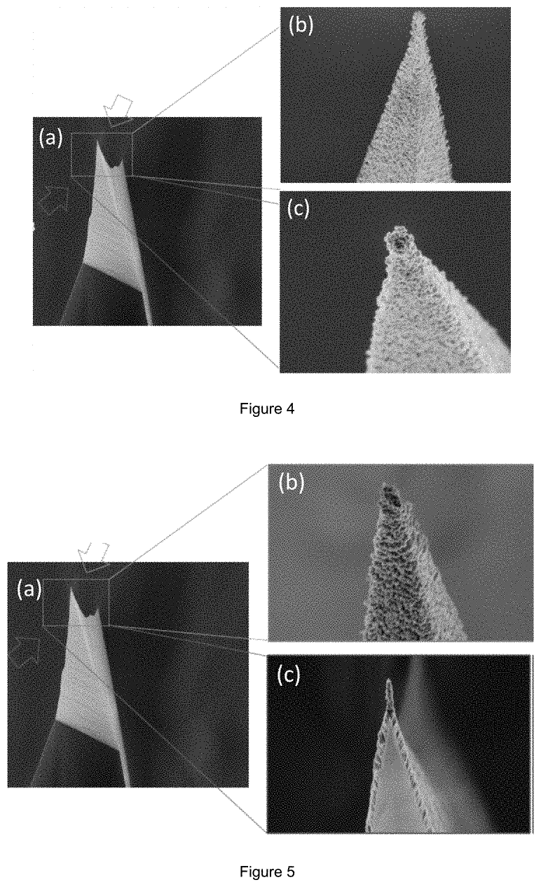

The tips coated with gold nanoparticles were studied by scanning electron microscopy (SEM). FIG. 2 shows SEM micrographs of the coated tips obtained in the present example. FIG. 2 shows a high density of nanoparticles deposited along the entire pyramid of the tip. In particular, FIG. 2(a) shows nanoparticle clusters deposited on the tip's sides and FIG. 2(b) shows a sharp cluster of nanoparticles at the apex of the coated tip; FIG. 2(c) shows both the clusters on the sides and the cluster at the apex of the tip. FIG. 3 shows a representation of the coated tip wherein further details can be observed about the (a) apex and about the lateral sides of the AFM tips. FIG. 4 shows SEM micrographs of the coated tips obtained in the present example. In particular, FIG. 4(b) and (c) show a homogenous coating which comprises clusters of nanoparticles that create coral-like protrusions (i.e. “branches”) on all the sides of the tip. In addition, FIG. 4(c) shows the formation of a nanoparticle cluster on the apex of the tip.

The authors of the present invention have observed that the movement of the tip during the coating ensures a homogeneous tip coating wherein all the sides (lateral surfaces) of the tip's pyramid have a similar amount of coating.

The coating increased the durability of the modified tips and their working-life, particularly while being used in atomic force microscopy. Moreover, the use of an ion cluster source (ICS) to generate and deposit the nanoparticles, ensure a high purity of the coating.

In addition, the nanostructures created on the tips enhance their performance. In particular, the nanoparticle cluster deposited on the apex of the coated tip, improves the tip sharpness and resolution. Furthermore the “branched” or coral-like clusters formed in the laterals of the tip by the deposited nanoparticles, enhance the tip's local surface plasmon resonance, lighting rod and/or antenna effects improving the tip's performance when it is used on tip enhanced Raman spectroscopy (TERS), scanning near-field optical microscopy (s-SNOM) and Fourier transform infrared spectroscopy (nano-FTIR) AFM techniques (among other techniques). When clusters are formed in the apex and in the laterals of the tip the tip's performance improves in all AFM applications. In addition, the authors of the present invention have observed that the modified SPM tip of the invention does not comprise a significant amount of impurities (i.e. the modified tips have a high purity). In particular, they have observed that the clusters and/or nanoparticles coating the modified SPM tip do not comprise a significant amount of impurities (they have a high purity), thus, leading to a reduced amount of interferences in the signal of the SPM tip.

### COMPARATIVE EXAMPLE 2: Coated Tips

In the present experiment, tips were coated using the same parameters as in Example 1 but the tip was static during the coating (without changing its position) method. FIG. 5 shows SEM micrographs of a coated tip obtained in the present example. FIG. 5(b) show that no particle aggregate or cluster was formed in the apex of the tip. FIG. 5(c) shows that only two sides of the tip's pyramid were coated. In addition, the nanoparticles deposited on the sides of the tip's pyramid form a continuous coating rather that coral-like clusters like in Example 1 (FIG. 5(b) or (c)).

### COMPARATIVE EXAMPLE 3

In the present experiment, the performance of a tip coated as in Example 1 was compared with the performance of a commercial (Pt/Ir) coated tip in a Fourier transform infrared (nano-FTIR) atomic force microscopy technique on a polymethyl methacrylate (PMMA) film coated silicon substrate. The commercial coated tip is an ArrowTM NCPt tip from NanoWorld® Arrow™ which is a tip made from monolithic silicon and coated with Pt and Ir. The Ptlr5 coating of the commercial tip consists of a 23 nm thick platinum iridium5 continuous layer deposited on both sides of the tip. The commercial tip does not comprise coral-like clusters in the sides of the tips or an oval cluster in the apex of the tip.

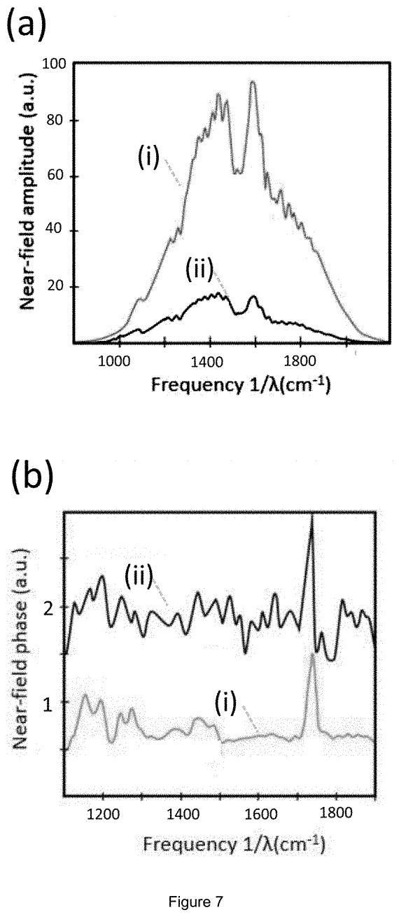

FIG. 7 shows (a) Near-field amplitude vs frequency and (b) Near-field phase vs frequency results measured on a substrate by nanoscale Fourier transform infrared (nano-FTIR) atomic force microscopy technique using a SPM coated tip (i) and a commercial tip (ii).

FIG. 7(a) results showed that using the SPM coated tip of Example 1 more intense bands of near-field amplitude are obtained than when using a commercial tip. FIG. 7(b) results showed that using the SPM coated tip of Example 1 less background noise contribution was obtained in the near-field phase spectra and a higher signal/noise ratio was obtained than when using a commercial tip.

### EXAMPLE 4

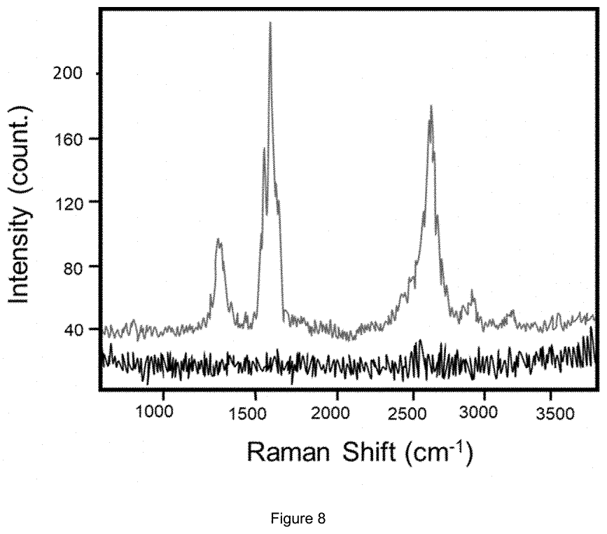

In the present experiment, the performance of a tip coated as in Example 1, was tested using a laser of 638 nm and 1 s acquisition time in a Tip Enhanced Raman spectroscopy (TERS) technique. As showed on FIG. 8, Raman spectra were acquired on a carbon nanotube CNT on a gold substrate sample using said tip. FIG. 8 shows the results of tip in (grey) and tip out (black)).

1. A method for modifying a scanning probe microscope (SPM) tip comprising the following steps:
(a) providing
a nanoparticle beam,
wherein the nanoparticle beam comprises a longitudinal axis X-X′ and an apex, wherein the longitudinal axis X-X′ passes through the apex of the nanoparticle beam and constitutes a symmetry axis;
a SPM tip,
wherein the SPM tip comprises an apex,
wherein the SPM tip comprises a longitudinal axis Y-Y′; wherein the longitudinal axis Y-Y′ passes through the apex of the SPM tip and constitutes a symmetry axis;
wherein the nanoparticle beam and/or the SPM tip perform a translational movement following a path on a xy plane around an axis W-W′, wherein the axis W-W′ is perpendicular to the xy plane,
wherein axis X-X′, axis Y-Y′ and axis W-W′ meet at a point of the xy plane, wherein the distance of the apex of the SPM tip to said point is less than the distance of the apex of the nanoparticle beam to said point;
(b) confronting the SPM tip with the nanoparticle beam, wherein in its translational movement, the SPM tip passes through at least:
a. a position (a) wherein the axis X-X′ and the axis Y-Y′ form an angle of between −10° and −80°; and
b. a position (b) wherein the axis X-X′ and the axis Y-Y′ form an angle of between −10° and +10° ; and
c. optionally, a position (c) wherein the axis X-X′ and the axis Y-Y′ form an angle of between +10° and +80°,
wherein the vertex of the angle is the point of the xy plane wherein axis X-X′, axis Y-Y′ and axis W-W′ meet.

2. The method according to claim 1, wherein the SPM tip is a pyramid, and/or the nanoparticle beam and/or the SPM tip, perform an optional rotational movement.

3. The method according to claim 1, wherein the SPM tip of step (a) comprises at least a continuous metal layer.

4. The method according to claim 1, wherein the SPM tip in step (b) stops at each position (a), (b) and (c) for at least 0.1 second.

5. The method according to claim 1, wherein step (b) is repeated.

6. The method according to claim 1, wherein the distance between the apex of the SPM tip to the apex of the nanoparticle beam is between 100 and 10000 mm, and optionally, wherein the nanoparticle density per micron and per second of the nanoparticle beam at the apex of the SPM tip, is between 100 and 2000 nanoparticles/micron per second.

7. The method according to claim 1, wherein the means suitable for generating a nanoparticle beam are an ion cluster source.

8. The method according to claim 1, wherein the nanoparticle beam comprises metal nanoparticles, wherein the metal of the metal nanoparticles is selected from Ag, and Au or a combination thereof, wherein the mean diameter of the nanoparticles is between 0.10 nm and 20 nm, and wherein the SPM tip stops at each position for at least 0.1 second.

9. A modified SPM tip obtainable by the method according to claim 1, comprising
an apex,
a base, and
at least a lateral surface,.
wherein the at least a lateral surface comprises nanoparticle clusters with lengths of at least 5 nm, wherein the nanoparticle clusters of the at least a lateral surface comprise a central rod and lateral protrusions,
wherein the nanoparticle clusters comprise metal nanoparticles with a mean diameter of between 0.1 and 20 nm, and
wherein the apex comprises a nanoparticle cluster optionally of between 2 and 500 nanoparticles.

10. A modified SPM tip comprising
an apex,
a base, and
at least a lateral surface,
wherein the at least a lateral surface comprises nanoparticle clusters with lengths of at least 5 nm, wherein the nanoparticle clusters of the at least a lateral surface of the SPM tip comprise a central rod and lateral protrusions,
wherein the nanoparticle clusters comprise metal nanoparticles with a mean diameter of between 0.1 and 20 nm, and
wherein the apex comprises a nanoparticle cluster optionally of between 2 and 500 nanoparticles.

11. The modified SPM tip according to claim 10, wherein the SPM tip comprises a longitudinal axis Y-Y′ that passes through the apex of the SPM tip and through the nanoparticle cluster of the apex of the SPM tip and constitutes a symmetry axis,
wherein the diameter of the nanoparticle cluster of the apex is perpendicular to the longitudinal axis Y-Y′, and
wherein the value of the diameter of the nanoparticle cluster along the longitudinal axis Y-Y′, is smaller in the closest point to the apex and in the furthest point from the apex than in between those points.

12. The modified SPM tip according to claim 10, wherein the nanoparticle cluster of the apex of the SPM tip has an oval, pinecone, pointed egg or artichoke shape.

13. The modified SPM tip according to claim 10, wherein the at least a lateral surface and the apex comprise at least a continuous metal layer coating, and wherein the nanoparticle clusters are on top of said at least a continuous metal layer.

14. The modified SPM tip according to claim 10, wherein the metal of the metal nanoparticles is selected from Ag, Au or a combination thereof, and the nanoparticles have a mean diameter of between 0.5 and 10 nm.

15. The modified SPM tip according to claim 10, wherein the nanoparticle clusters of the at least a lateral surface of the SPM tip have a coral-like shape or a branched shape.

16. The modified SPM tip according to claim 10, wherein all the lateral surfaces of the SPM tip comprise nanoparticle clusters.

17. (canceled)

18. (canceled)

19. A scanning probe comprising the modified SPM tip according to claim 10 on a cantilever.

20. (canceled)

21. (canceled)

22. The method according to claim 1, wherein the SPM tip in step (b) passes through at least a position (b) wherein the axis X-X′ and the axis Y-Y′ form an angle of 0°.
